(19) United States
(12) Patent Application Publication
(10) Pub. No.: US 2013/0030636 A1
(43) Pub. Date: Jan. 31, 2013

(54) TRAVELING APPARATUS AND CONTROL METHOD AND CONTROL PROGRAM THEREOF

(71) Applicant: Hikaru Sugata, Miyoshi-shi (JP)

(72) Inventor: Hikaru Sugata, Miyoshi-shi (JP)

(73) Assignee: TOYOTA JIDOSHA KABUSHIKI KAISHA, Toyota-shi (JP)

(21) Appl. No.: 13/639,794

(22) PCT Filed: Apr. 6, 2010
(86) PCT No.: PCT/JP2010/002505

§ 371 Date: Oct. 5, 2012

(51) Int. Cl. B60K 1/02

(52) U.S. Cl. 701/22

(57) ABSTRACT

A traveling apparatus includes first and second drive wheels; a first motor that drives the first drive wheel; a second motor that drives the second drive wheel; a switch that switches a drive shaft of the first drive wheel and a drive shaft of the second drive wheel between a coupled state and a non-coupled state; an abnormality detector that detects an abnormal state in the first and second motors; and a controller that controls switching of the switch based on the abnormal state detected by the abnormality detector. When the abnormality detector detects the abnormal state, the controller may control the switch to switch the drive shaft of the first drive wheel and the drive shaft of the second drive wheel from the non-coupled state to the coupled state.

### TECHNICAL FIELD

The present invention relates to a traveling apparatus that travels by driving drive wheels using motors, control method and program thereof.

### BACKGROUND ART

There is known a traveling apparatus including a first drive wheel, a second drive wheel, a first motor that drives the first drive wheel, and a second motor that drives the second drive wheel (see Patent Literature 1), for example.

### CITATION LIST

### Patent Literature

[Patent Literature 1] Japanese Unexamined Patent Application Publication No. 2006-315666

### SUMMARY OF INVENTION

### Technical Problem

In the traveling apparatus, a dual driving system can be configured so as to allow the traveling apparatus to travel even if an abnormality occurs in each motor. In this case, however, when backup motors are provided to the first and second motors, four motors in total are required, which leads to an increase in cost.

The present invention has been made to solve the above-mentioned problem, and it is a main object to provide a traveling apparatus that achieves low cost, control method and program thereof.

### Solution to Problem

One aspect of the present invention to achieve the above-mentioned object is a traveling apparatus including: a first drive wheel and a second drive wheel; a first motor that drives the first drive wheel; a second motor that drives the second drive wheel; switching means that switches a drive shaft of the first drive wheel and a drive shaft of the second drive wheel between a connected state and a non-connected state; abnormality detection means that detects an abnormal state in the first and second motors; and control means that controls switching of the switching means based on the abnormal state detected by the abnormality detection means.

In this one aspect, when the abnormality detection means detects the abnormal state, the control means may control the switching means to switch the drive shaft of the first drive wheel and the drive shaft of the second drive wheel from the non-connected state to the connected state.

Another aspect of the present invention to achieve the above-mentioned object may be a traveling apparatus including: a first drive wheel and a second drive wheel; a first motor that drives the first drive wheel; a second motor that drives the second drive wheel; first switching means that switches a drive shaft of the first drive wheel and the first motor between a connected state and a non-connected state; second switching means that switches a drive shaft of the second drive wheel and the second motor between the connected state and the non-connected state; third switching means that switches the drive shaft of the first drive wheel and the drive shaft of the second drive wheel between the connected state and the non-connected state; abnormality detection means that detects an abnormal state in the first and second motors; and control means that controls the switching of the first, second, and third switching means based on the abnormal state detected by the abnormality detection means.

In this another aspect, when the abnormality detection means detects the abnormal state, the control means may control the first and second switching means located on a side where the abnormal state is detected, to be brought into the non-connected state from the connected state, and may control the third switching means to be brought into the connected state from the non-connected state.

Still another aspect of the present invention to achieve the above-mentioned object may be a traveling apparatus including: a first drive wheel and a second drive wheel; a first motor that drives the first drive wheel; a second motor that drives the second drive wheel; a first planetary gear engaging with each of the first drive wheel and the first motor; a second planetary gear engaging with each of the second drive wheel and the second motor; an intermediate shaft engaging with each of the first and second planetary gears; a third motor that drives the intermediate shaft; first locking means that brings a rotation of the first motor into a locked state and a released state; second locking means that brings a rotation of the second motor into the locked state and the released state; third locking means that brings a rotation of the intermediate shaft into the locked state and the released state; abnormality detection means that detects an abnormal state in the first and second motors; and control means that controls the first, second, and third locking means to be brought into the locked state and the released state based on the abnormal state detected by the abnormality detection means.

In this still another aspect, when the abnormality detection means detects the abnormal state, the control means may control the first and second locking means located on a side where the abnormal state is detected, to be brought into the locked state from the released state, and may control the third locking means to be brought into the released state from the locked state.

Note that in this still another aspect, the first and second planetary gears respectively include: ring gears respectively engaging with gears connected to the drive shafts of the first and second motors; a plurality of planetary gears respectively engaging with the ring gears and connected to the intermediate shaft; and sun gears respectively engaging with the planetary gears and connected to axles of the first and second drive wheels.

Further another aspect of the present invention to achieve the above-mentioned object may be a traveling apparatus including: a first drive wheel and a second drive wheel; a first motor that drives the first drive wheel; a second motor that drives the second drive wheel; an intermediate shaft that connects a drive shaft of the first drive wheel and a drive shaft of the second drive wheel; a third motor that drives the intermediate shaft; first switching means that switches the drive shaft of the first drive wheel and the intermediate shaft between a connected state and a non-connected state; second switching means that switches the drive shaft of the second drive wheel and the intermediate shaft between the connected state and the non-connected state; abnormality detection means that detects an abnormal state in the first and second motors; and control means that controls the first and second switching means to be brought into the connected state and the non-connected state based on the abnormal state detected by the abnormality detection means.

In this further another aspect, when the abnormality detection means detects the abnormal state, the control means may control the first and second switching means located on a side where the abnormal state is detected, to be brought into the connected state from the non-connected state.

Further another aspect of the present invention to achieve the above-mentioned object may be a control method of a traveling apparatus, the traveling apparatus including: a first drive wheel and a second drive wheel; a first motor that drives the first drive wheel; and a second motor that drives the second drive wheel, the control method including the steps of: switching a drive shaft of the first drive wheel and a drive shaft of the second drive wheel between a connected state and a non-connected state; detecting an abnormal state in the first and second motors; and controlling the switching based on the abnormal state detected.

Further another aspect of the present invention to achieve the above-mentioned object may be a control method of a traveling apparatus, the traveling apparatus including: a first drive wheel and a second drive wheel; a first motor that drives the first drive wheel; and a second motor that drives the second drive wheel, the control method including the steps of: switching a drive shaft of the first drive wheel and the first motor between a connected state and a non-connected state; switching a drive shaft of the second drive wheel and the second motor between the connected state and the non-connected state; switching the drive shaft of the first drive wheel and the drive shaft of the second drive wheel between the connected state and the non-connected state; detecting an abnormal state in the first and second motors; and controlling the switching based on the abnormal state detected.

Further another aspect of the present invention to achieve the above-mentioned object may be a control method of a traveling apparatus, the traveling apparatus including: a first drive wheel and a second drive wheel; a first motor that drives the first drive wheel; a second motor that drives the second drive wheel; a first planetary gear engaging with each of the first drive wheel and the first motor; a second planetary gear engaging with each of the second drive wheel and the second motor; an intermediate shaft engaging with each of the first and second planetary gears; and a third motor that drives the intermediate shaft, the control method including the steps of: bringing a rotation of the first motor into a locked state and a released state; bringing a rotation of the second motor into the locked state and the released state; bringing a rotation of the intermediate shaft into the locked state and the released state; detecting an abnormal state in the first and second motors; and controlling the locked state and the released state based on the abnormal state detected.

Further another aspect of the present invention to achieve the above-mentioned object may be a control method of a traveling apparatus, the traveling apparatus including: a first drive wheel and a second drive wheel; a first motor that drives the first drive wheel; a second motor that drives the second drive wheel; an intermediate shaft that connects a drive shaft of the first drive wheel and a drive shaft of the second drive wheel; and a third motor that drives the intermediate shaft, the control method including the steps of: switching the drive shaft of the first drive wheel and the intermediate shaft between a connected state and a non-connected state; switching the drive shaft of the second drive wheel and the intermediate shaft between the connected state and the non-connected state; detecting an abnormal state in the first and second motors; and controlling the connected state and the non-connected state based on the abnormal state detected.

Further another aspect of the present invention to achieve the above-mentioned object may be a control program of a traveling apparatus, the traveling apparatus including: a first drive wheel and a second drive wheel; a first motor that drives the first drive wheel; and a second motor that drives the second drive wheel, the control program causing a computer to execute processing including: switching a drive shaft of the first drive wheel and a drive shaft of the second drive wheel between a connected state and a non-connected state; detecting an abnormal state in the first and second motors; and controlling the switching based the abnormal state detected.

### Advantageous Effects of Invention

According to the present invention, it is possible to provide a traveling apparatus that achieves low cost, control method and program thereof.

### BRIEF DESCRIPTION OF DRAWINGS

FIG. 1 is a block diagram showing a schematic system configuration of a traveling apparatus according to a first embodiment of the present invention;

FIG. 2 is a flowchart showing an example of a control processing flow of the traveling apparatus according to the first embodiment of the present invention;

FIG. 3 is a diagram showing an example of a control state when first and second motors are in a normal state;

FIG. 4 is a diagram showing an example of a control state when the second motor is in an abnormal state;

FIG. 5 is a diagram showing a modified example of the traveling apparatus according to the first embodiment of the present invention;

FIG. 6 is a diagram showing a modified example of the traveling apparatus according to the first embodiment of the present invention;

FIG. 7 is a block diagram showing a schematic system configuration of a traveling apparatus according to a second embodiment of the present invention;

FIG. 8 is a flowchart showing an example of a control processing flow of the traveling apparatus according to the second embodiment of the present invention;

FIG. 9 is a diagram showing an example of a control state when the first and second motors are in the normal state;

FIG. 10 is a diagram showing an example of a control state when the second motor is in the abnormal state;

FIG. 11 is a diagram showing a modified example of the traveling apparatus according to the second embodiment of the present invention;

FIG. 12 is a diagram showing a modified example of the traveling apparatus according to the second embodiment of the present invention;

FIG. 13 is a block diagram showing a schematic system configuration of a traveling apparatus according to a third embodiment of the present invention;

FIG. 14 is a perspective view showing a schematic configuration of each of first and second planetary gears;

FIG. 15 is a flowchart showing a control processing flow of the traveling apparatus according to the third embodiment of the present invention;

FIG. 16 is a diagram showing an example of a control state when the first and second motors are in the normal state;

FIG. 17 is a diagram showing an example of a control state when the second motor in the abnormal state;

FIG. 18 is a diagram showing a modified example of the traveling apparatus according to the third embodiment of the present invention;

FIG. 19 is a block diagram showing a schematic system configuration of a traveling apparatus according to a fourth embodiment of the present invention;

FIG. 20 is a flowchart showing an example of a control processing flow of the traveling apparatus according to the fourth embodiment of the present invention;

FIG. 21 is a diagram showing an example of a control state when the first and second motors are in the normal state; and

FIG. 22 is a diagram showing an example of a control state when the second motor in the abnormal state.

### DESCRIPTION OF EMBODIMENTS

### First Embodiment

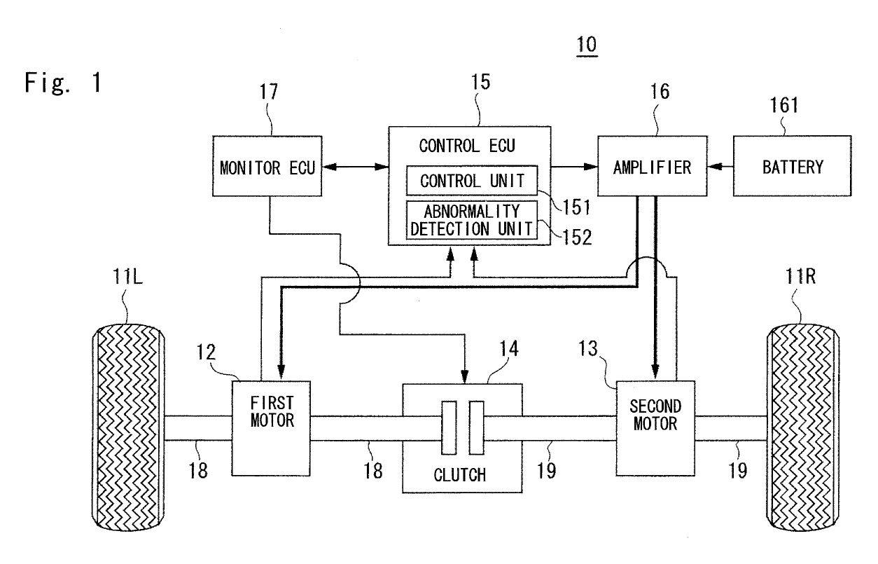

Hereinafter, embodiments of the present invention will be described with reference to the drawings. FIG. 1 is a block diagram showing a schematic system configuration of a traveling apparatus according to a first embodiment of the present invention. A traveling apparatus 10 according to the first embodiment includes a pair of a first drive wheel 11L and a second drive wheel 11R, which are provided at right and left sides, first and second motors 12 and 13, a clutch 14, a control ECU (Electric Control Unit) 15, an amplifier 16, and a monitor ECU 17.

The first motor 12 is connected to the first drive wheel 11L via a drive shaft 18, and rotationally drives the first drive wheel 11L in a forward or reverse direction. Similarly, the second motor 13 is connected to the second drive wheel 11R via a drive shaft 19, and rotationally drives the second drive wheel 11R in a forward or reverse direction. The first and second motors 12 and 13 are each connected to the control ECU 15 via the amplifier 16, and control the rotational direction and driving torque according to a control instruction from the control ECU 15.

The clutch 14 is a specific example of switching means, and switches the drive shaft 18 of the first drive wheel 11L and the drive shaft 19 of the second drive wheel 11R between a connected state in which the drive shafts are connected to be interlocked and a non-connected state in which the connected state is released.

The control ECU 15 includes a control unit 151 that controls the first and second motors 12 and 13, and an abnormality detection unit 152 that detects an abnormal state of the first and second motors 12 and 13. Each of the control ECU 15 and the monitor ECU 17 is configured by hardware with a microcomputer as a center. The microcomputer includes a CPU (Central Processing Unit) that executes control processing, arithmetic processing, and the like, a ROM (Read Only Memory) storing control programs, operation programs, and the like to be executed by the CPU, and a RAM (Random Access Memory) storing processing data and the like, for example.

The control unit 151 transmits a control signal to the amplifier 16 to thereby control the rotational driving of each of the first and second motors 12 and 13 through the amplifier 16. The control unit 151 controls the rotational driving of each of the first and second motors 12 and 13 so as to perform desired traveling (forward movements, backward movements, acceleration, deceleration, stops, left turn, right turn, etc.), while performing inversion control to maintain the inverted state of the traveling apparatus 10 according to a manipulation signal output from a manipulation unit, for example.

More specifically, the control unit 151 controls the first and second motors 12 and 13 to rotate in the forward direction at the same speed through the amplifier 16 to thereby allow the traveling apparatus 10 to move forward, and controls the first and second motors 12 and 13 to rotate in the reverse direction at the same speed to thereby allow the traveling apparatus 10 to move backward. Further, the control unit 151 performs control to generate a difference between the rotation of the first motor 12 and the rotation of the second motor 13 to thereby allow the traveling apparatus 10 to turn right or left.

The abnormality detection unit 152 is a specific example of abnormality detection means, and detects an abnormal state of the first and second motors 12 and 13 based on a current value or a voltage value output from a current sensor or a voltage sensor incorporated in each of the first and second motors 12 and 13. For example, when the current value or voltage value output from one of the first and second motors 12 and 13 is equal to or greater than a predetermined threshold, the abnormality detection unit 152 detects an abnormal state of one of the first and second motors 12 and 13. Upon detecting the abnormal state of one of the first and second motors 12 and 13, the abnormality detection unit 152 outputs a detection signal to the monitor ECU 17.

The amplifier 16 controls electric power supplied from a battery 161 according to a control signal output from the control ECU 15, and supplies the electric power to each of the first and second motors 12 and 13.

The monitor ECU 17 is a specific example of control means, and controls the clutch 14 to be brought into the connected state and the non-connected state according to the detection signal from the abnormality detection unit 152 of the control ECU 15. Note that in the first embodiment, the control ECU 15 includes the abnormality detection unit 151, but the monitor ECU 17 may include the abnormality detection unit 152.

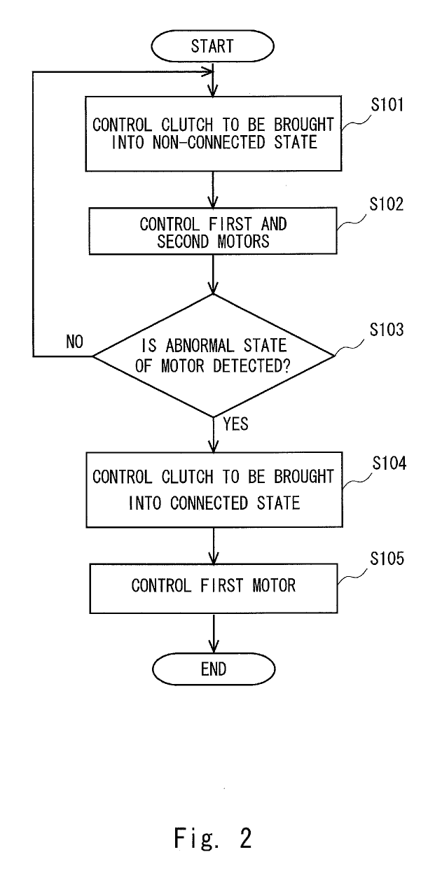

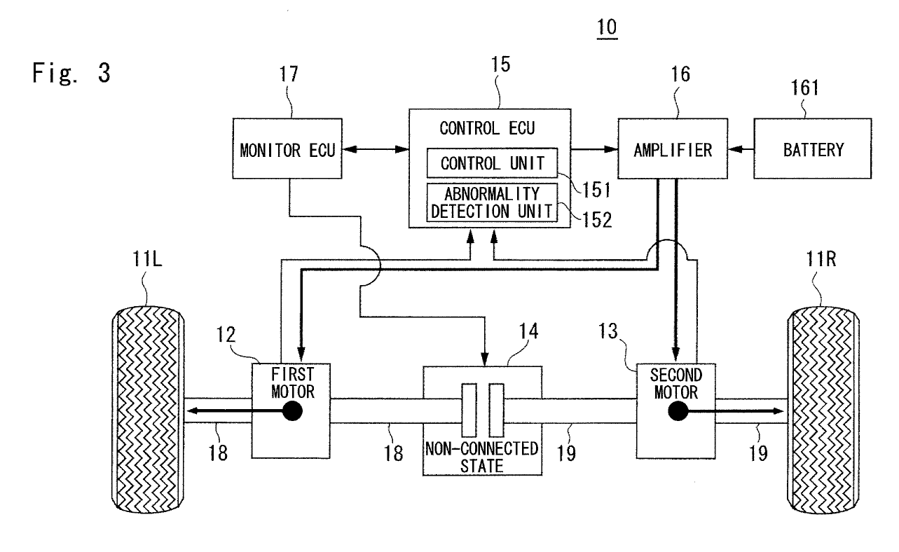

FIG. 2 is a flowchart showing an example of a control processing flow of the traveling apparatus according to the first embodiment. When the first and second motors 12 and 13 are in a normal state, for example, as shown in FIG. 3, the monitor ECU 17 receives no detection signal from the abnormality detection unit 152 of the control ECU 15, and thus controls the clutch 14 to be brought into the non-connected state (step S101). In this state, the control ECU 15 controls the rotational driving of each of the first and second motors 12 and 13 through the amplifier 16 (step S102), and controls the rotational driving of each of the first and second drive wheels 11L and 11R.

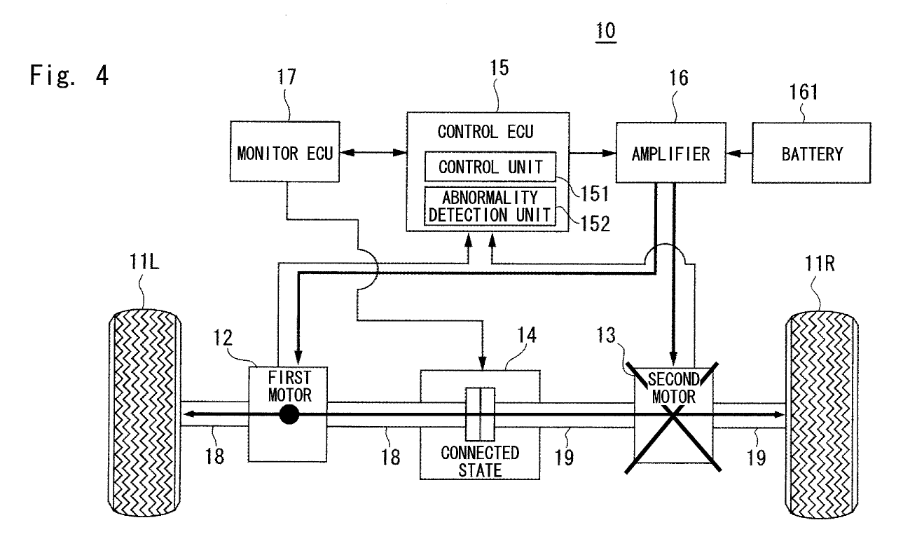

After that, as shown in FIG. 4, for example, if the second motor 13 breaks down, the abnormality detection unit 151 of the control ECU 15 detects the abnormal state of the second motor 13 based on the current value output from the current sensor of the second motor 13 (YES in step S103), and outputs the detection signal to the monitor ECU 17.

The monitor ECU 17 controls the clutch 14 to be brought into the connected state from the non-connected state based on the detection signal from the abnormality detection unit 151 (step S104). In this state, the control ECU 15 controls the rotational driving of the first motor 12 through the amplifier 16 (step S105), thereby enabling control of the rotational driving of the first drive wheel 11L and the rotational driving of the second driving wheel 11R through the clutch 14 and the drive shaft 19. This allows the control ECU 15 to maintain the inversion control of the traveling apparatus 10 and to control traveling such as forward movements and backward movements.

Note that in the above description, the case where the abnormal state of the second motor 13 is detected has been described. Also in the case where the abnormal state of the first motor 12 is detected, control processing similar to that for the first motor 12 described above is carried out. Accordingly, the detailed description thereof is omitted.

As described above, in the traveling apparatus 10 according to the first embodiment, when the abnormality detection unit 151 detects the abnormal state of one of the first and second motors 12 and 13, the control ECU 15 controls the clutch 14 so that the drive shaft 18 of the first drive wheel 11L and the drive shaft 19 of the second drive wheel 11R is switched from the non-connected state to the connected state.

Consequently, even if an abnormality occurs in one of the first and second motors 12 and 13, the inversion control of the traveling apparatus 10 can be maintained without newly providing a backup motor, and traveling such as forward movements and backward movements can be controlled. That is, it is possible to maintain the safety and convenience, while achieving low cost. In particular, even if an abnormality occurs in one of the motors 12 and 13 in the traveling apparatus 10 that performs inversion control, the inverted state of the traveling apparatus is reliably maintained, resulting in an improvement in safety.

Next, a modified example of the traveling apparatus according to the first embodiment will be described.

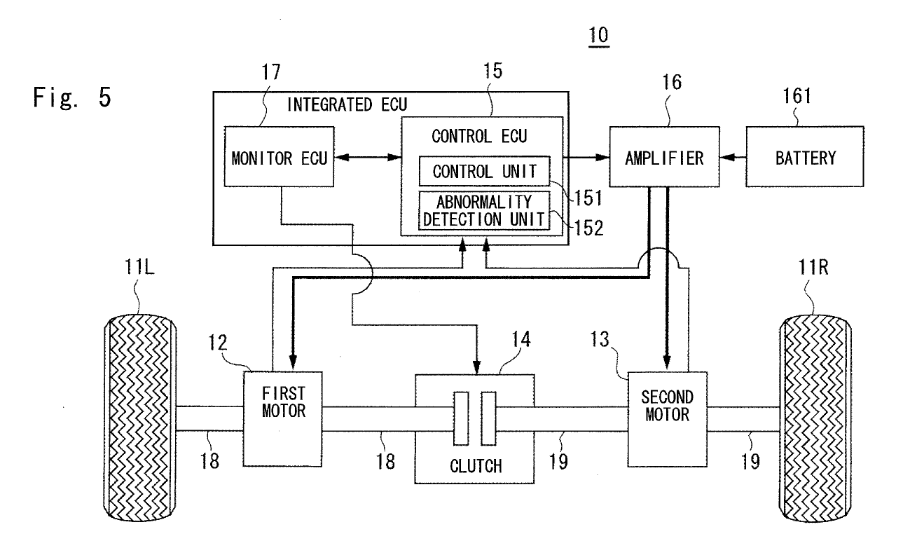

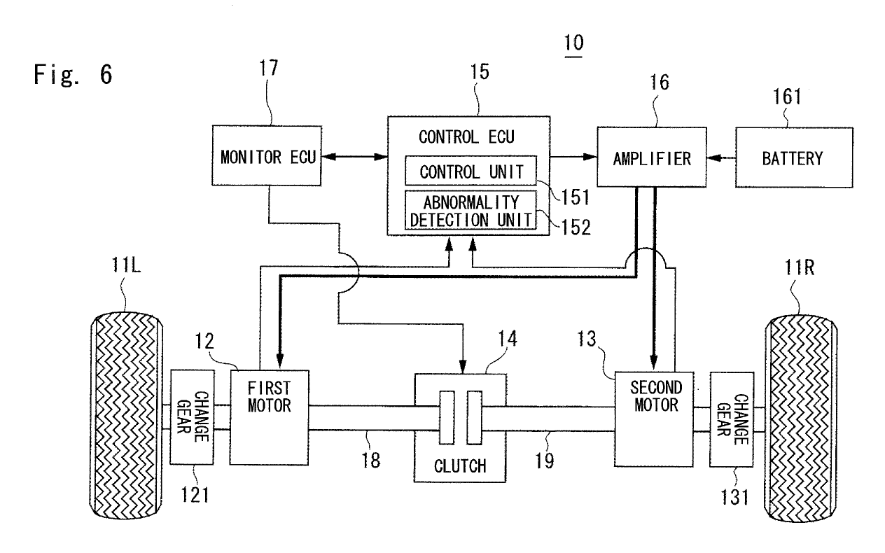

For example, in the first embodiment described above, the control ECU 15 and the monitor ECU 17 are configured separately, but the control ECU 15 and the monitor ECU 17 may be configured in an integrated manner (FIG. 5). Alternatively, the control ECU 15 and the amplifier 16 may be configured in an integrated manner. Further, in the first embodiment described above, the first and second motors 12 and 13 may be configured to rotationally drive the first and second drive wheels 11L and 11R through change gears (reduction gear) 121 and 131, respectively (FIG. 6).

### Second Embodiment

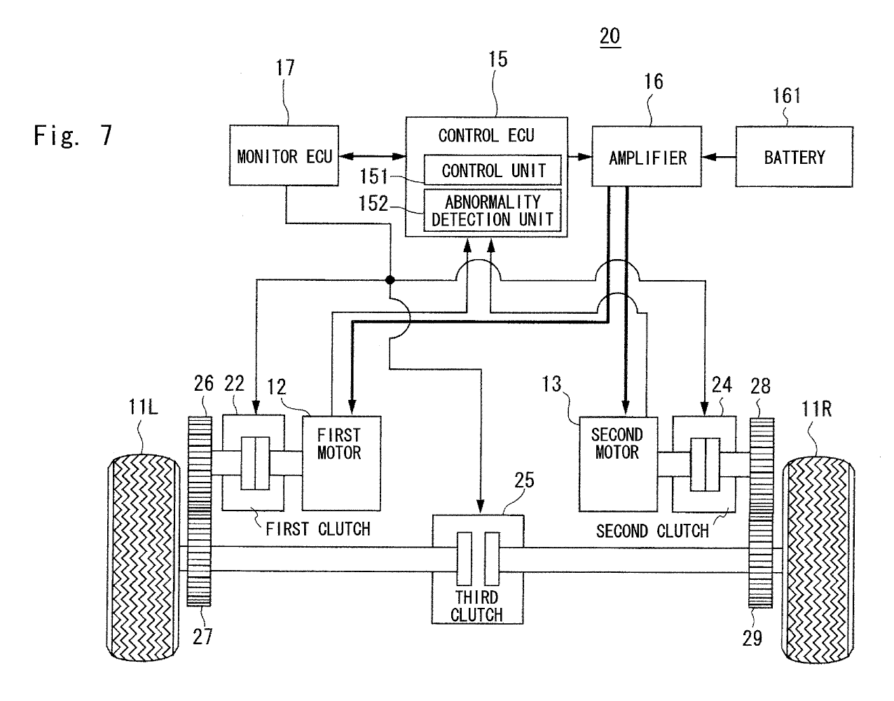

FIG. 7 is a block diagram showing a schematic system configuration of a traveling apparatus according to a second embodiment of the present invention. A traveling apparatus 20 according to the second embodiment includes a first clutch 22 that switches a first shaft 21 of the first drive wheel 11L and the first motor 12 between a connected state and a non-connected state; a second clutch 24 that switches a drive shaft 23 of the second drive wheel 11R and the second motor 13 between the connected state and the non-connected state; a third clutch 25 that switches the drive shaft 21 of the first drive wheel 11L and the drive shaft 23 of the second drive wheel 11R between the connected state and the non-connected state; and the monitor ECU 17 that controls the switching of each of the first, second, and third clutches 22, 24, and 25.

The drive shaft of the first motor 12 is connected to one end of the first clutch 22, and a gear 26 is connected to the other end thereof. The gear 26 of the first clutch 22 engages with a gear 27 which is connected to the drive shaft 21 of the first drive wheel 11L. Similarly, the drive shaft of the second motor 13 is connected to one end of the second clutch 24, and a gear 28 is connected to the other end of the second clutch 24. The gear 28 of the second clutch 24 engages with a gear 29 which is connected to the drive shaft 23 of the second drive wheel 11R. The third clutch 25 is provided between the drive shaft 21 of the first drive wheel 11L and the drive shaft 23 of the second drive wheel 11R, and switches the drive shaft 21 of the first drive wheel 11L and the drive shaft 23 of the second drive wheel 11R between the connected state and the non-connected state.

The monitor ECU 17 controls the first, second, and third clutches 22, 24, and 25 to be brought into the connected state and the non-connected state according to the detection signal from the abnormality detection unit 152 of the control ECU 15.

In the traveling apparatus 20 according to the second embodiment, the other components are substantially the same as those of the traveling apparatus 10 according to the first embodiment described above. Accordingly, identical parts are denoted by the same reference numerals, and the detailed description thereof is omitted.

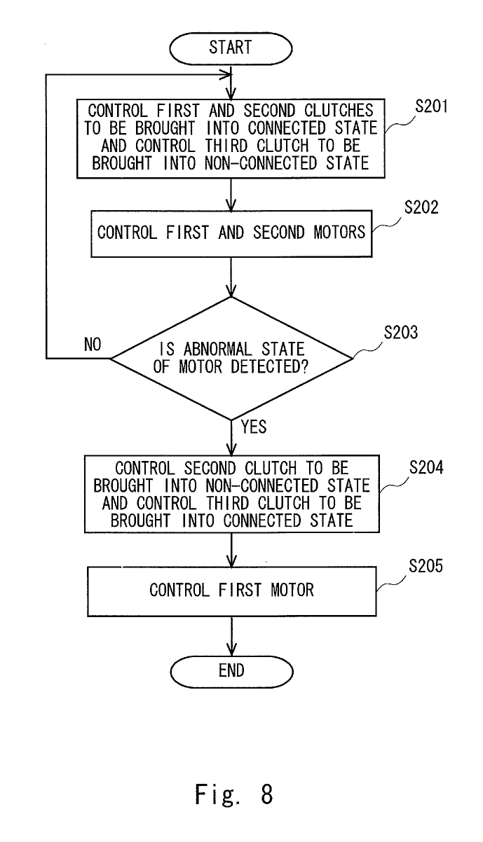

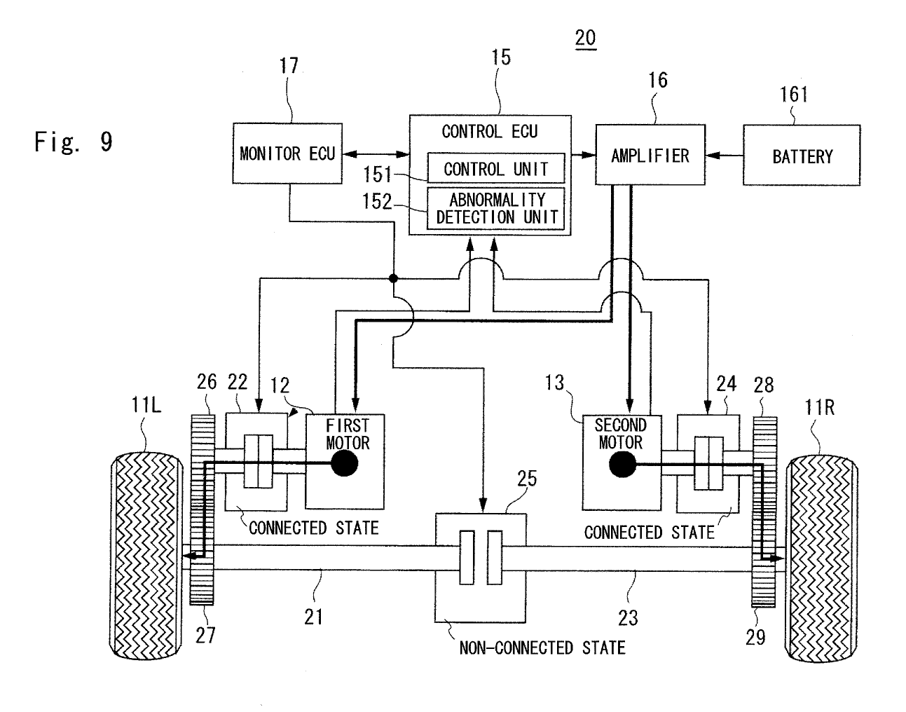

FIG. 8 is a flowchart showing an example of a control processing flow of the traveling apparatus according to the second embodiment. When the first and second motors 12 and 13 are in the normal state, for example, as shown in FIG. 9, the monitor ECU 17 receives no detection signal from the abnormality detection unit 152 of the control ECU 15, and thus controls the first and second clutches 22 and 24 to be brought into the connected state and controls the third clutch 25 to be brought into the non-connected state (step S201). In this state, the control ECU 15 controls the rotational driving of each of the first and second motors 12 and 13 through the amplifier 16 (step S202). The first motor 12 controls the rotational driving of the first drive wheel 11L through the first clutch 22, the gears 26 and 27, and the drive shaft 21. The second motor 13 controls the rotational driving of the second drive wheel 11R through the second clutch 24, the gears 28 and 29, and the drive shaft 23.

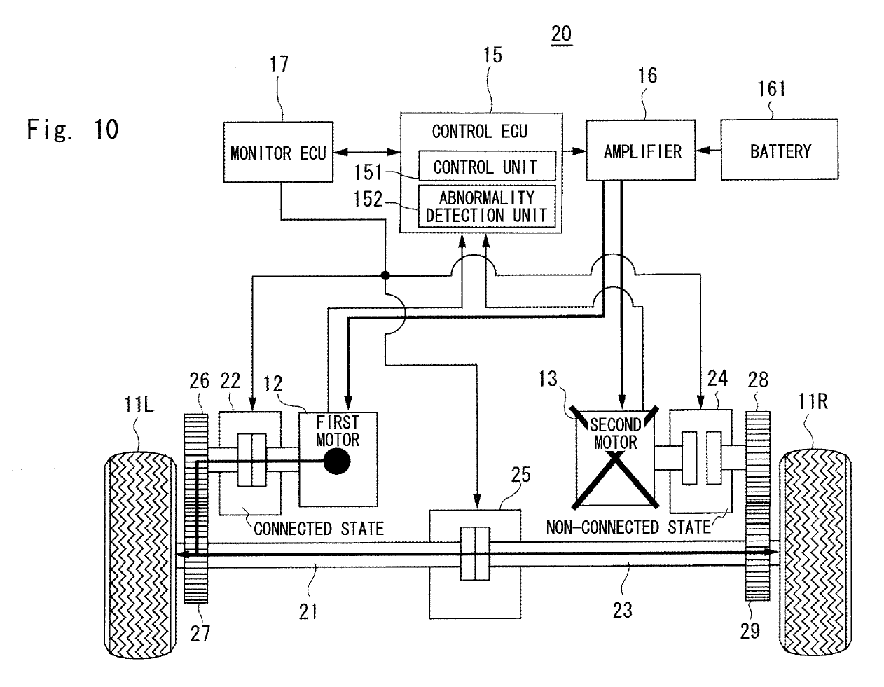

After that, as shown in FIG. 10, for example, if the second motor 13 breaks down, the abnormality detection unit 152 of the control ECU 15 detects the abnormality state of the second motor 13 based on the current value output from the current sensor of the second motor 13 (YES in step S203), and outputs the detection signal to the monitor ECU 17.

The monitor ECU 17 controls the second clutch 24, which is located on the side where the abnormal state is detected, to be brought into the non-connected state from the connected state, and controls the third clutch 25 to be brought into the connected state from the non-connected state, based on the detection signal from the abnormality detection unit 152 of the control ECU 15 (step S204). In this state, the control ECU 15 controls the rotational driving of the first motor 12 through the amplifier 16 (step S205), thereby enabling control of the rotational driving of the first drive wheel 11L through the first clutch 22, the gears 26 and 27, and the drive shaft 21, and the rotational driving of the second drive wheel 11R through the third clutch 25 and the drive shaft 23.

Note that in the above description, the case where the abnormal state of the second motor 13 is detected has been described. Also in the case where the abnormal state of the first motor 12 is detected, control processing similar to that for the first motor 12 described above is carried out. Accordingly, the detailed description thereof is omitted.

As described above, in the traveling apparatus 20 according to the second embodiment, even if an abnormality occurs in one of the first and second motors 12 and 13, the inversion control of the traveling apparatus 20 can be maintained without newly providing a backup motor, and traveling such as forward movements and backward movements can be controlled. Further, one of the first and second clutches 22 and 24, which is located on the same side of one of the first and second motors 12 and 13 in the abnormal state, is controlled to be brought into the non-connected state, and one of the first and second drive wheels 11 L and 11R, which is located on the same side of the one of the first and second motors 12 and 13, is completely disconnected from the one of the first and second motors 12 and 13. This eliminates a regeneration resistance which is generated when one of the first and second motors 12 and 13 in the abnormal state interlocks with one of the first and second drive wheels 11L and 11R, thereby improving the energy efficiency. That is, it is possible to save electric power, while achieving low cost.

Next, a modified example of the traveling apparatus according to the second embodiment will be described.

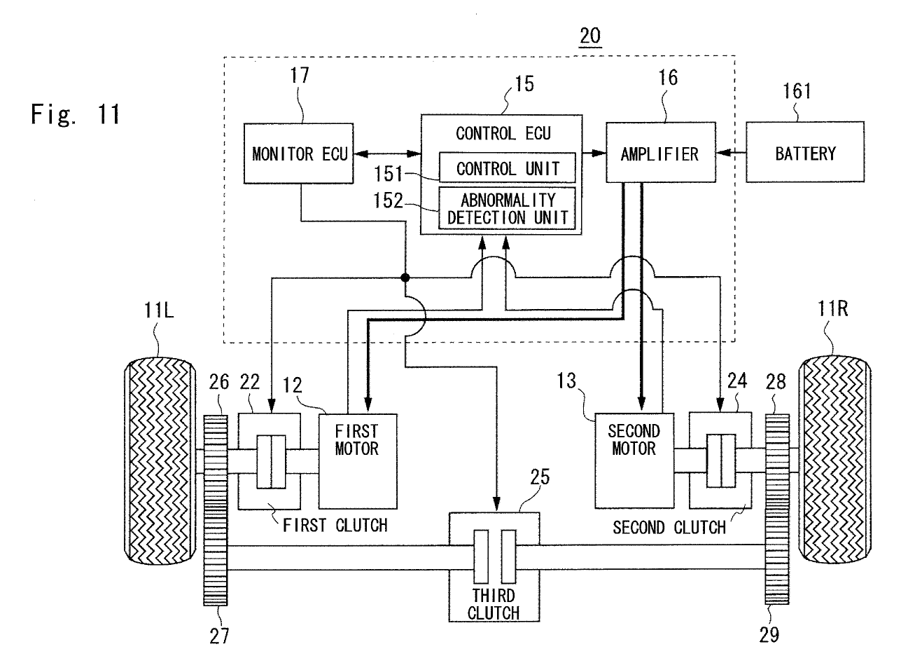

For example, in the second embodiment described above, the control ECU 15, the monitor ECU 17, and the amplifier 16 are configured separately, but the control ECU 15, the monitor ECU 17, and the amplifier 16 may be configured in an integrated manner (FIG. 11). Further, in the second embodiment described above, the first drive wheel 11L and the second drive wheel 11R are connected to the gears 27 and 29, respectively, but may be connected to the gears 26 and 28, respectively (FIG. 11).

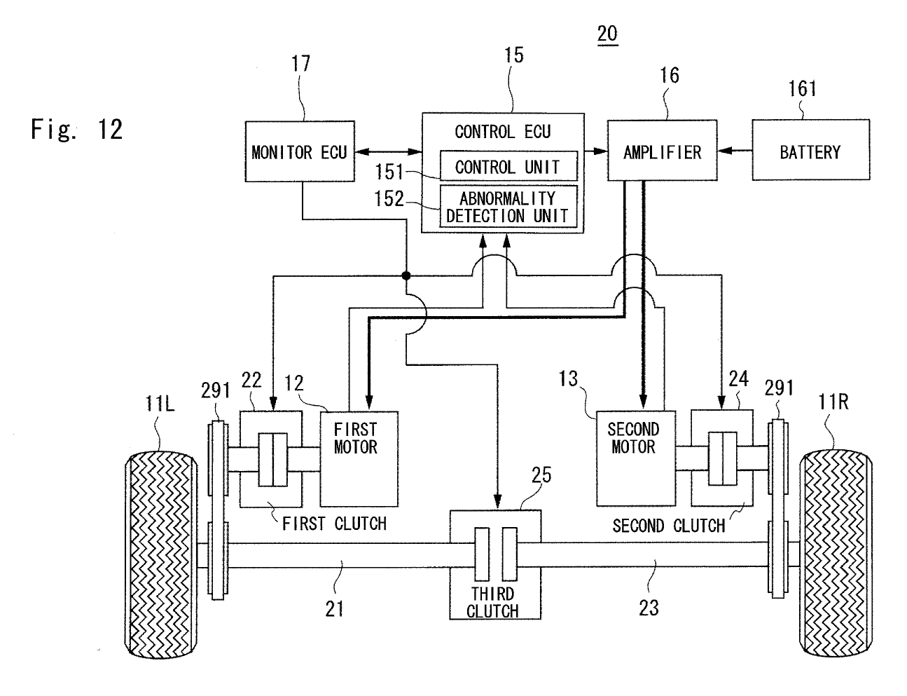

Furthermore, in the second embodiment described above, the first and second clutches 22 and 24 are respectively connected to the drive shafts 21 and 23 of the first and second drive wheels 11L and 11R through the gears 26 and 27 and the gears 28 and 29. Alternatively, the first and second clutches 22 and 24 may be respectively connected to the drive shafts 21 and 23 of the first and second drive wheels 11L and 11R through a transmission member such as a belt 291 or a chain (FIG. 12).

### Third Embodiment

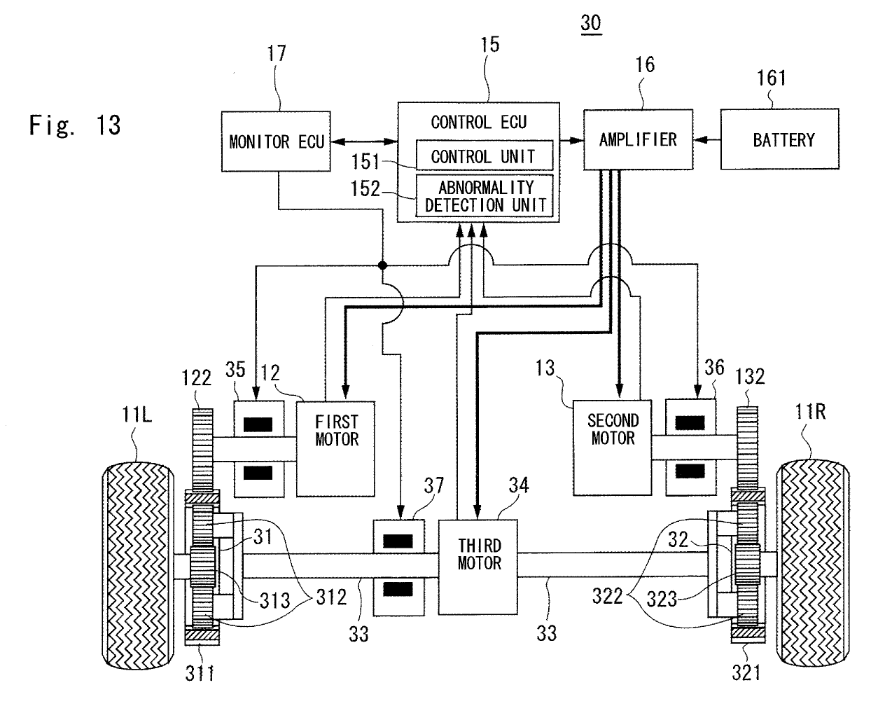

FIG. 13 is a block diagram showing a schematic system configuration of a traveling apparatus according to a third embodiment of the present invention. A traveling apparatus 30 according to the third embodiment includes a first planetary gear 31 that engages with each of the first drive wheel 11L and the first motor 12; a second planetary gear 32 that engages with each of the second drive wheel 11R and the second motor 13; an intermediate shaft 33 which engages with each of the first and second planetary gears 31 and 32; a third motor 34 that drives the intermediate shaft; a first locking device 35 that brings the rotation of the first motor 12 into a. locked state and a released state; a second locking device 36 that brings the rotation of the second motor 13 into the locked state and the released state; a third locking device 37 that brings the rotation of the intermediate shaft 33 into the locked state and the released state; and the monitor ECU 17 that controls the first, second, and third locking devices 35, 36, and 37 to be brought into the locked state and the released state.

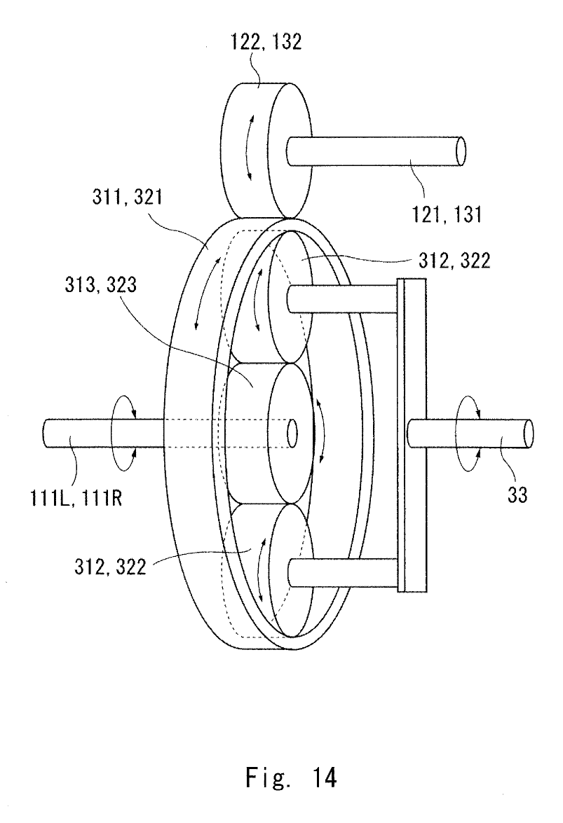

As shown in FIG. 14, the first and second planetary gears 31 and 32 respectively include ring gears 311 and 321 which engage with gears 122 and 132 connected to the drive shafts 121 and 131 of the first and second motors 12 and 13, respectively; a pair of planetary gears 312 and 322 which engage with the ring gears 311 and 321, respectively, and are connected to the intermediate shaft 33; and sun gears 313 and 323 which engage with the planetary gears 312 and 322 and are connected to axles 111L and 111R of the first and second drive wheels 11L and 11R, respectively. Note that the first and second planetary gears 31 and 32 respectively include the pair of planetary gears 312 and 322, but the configuration of the first and second planetary gears 31 and 32 is not limited thereto. Any configuration, such as a configuration including three, four, or more planetary gears, may be employed.

The third motor 34 is provided to the intermediate shaft 33, and is connected to the control ECU 15 via the amplifier 16. The control ECU 15 transmits the control signal to the amplifier 16, thereby controlling the rotational driving of the third motor 34 through the amplifier 16.

The first locking device 35 is a specific example of first locking means, and is provided to the drive shaft 121 of the first motor 12. The first locking device 35 can bring the rotation of the drive shaft 121 of the first motor 12 into the locked state in which the rotation of the drive shaft 121 is locked, or into the released state in which the locked state is released to enable rotation. Similarly, the second locking device 36 is a specific example of second locking means, and is provided to the drive shaft 131 of the second motor 13. The second locking device 36 can bring the rotation of the drive shaft 131 of the second motor 13 into the locked state in which the rotation of the drive shaft 131 is locked, or into the released state in which the locked state is released to enable rotation.

The third locking device 37 is a specific example of third locking means, and is provided to the intermediate shaft 33. The third locking device 37 can bring the rotation of the intermediate shaft 33 into the locked state in which the rotation of the intermediate shaft 33 is locked, or into the released state in which the locked state is released to enable rotation.

The monitor ECU 17 controls the first, second, and third locking devices 35, 36, and 37 to be brought into the locked state and the released state according to the detection signal from the abnormality detection unit 152 of the control ECU 15.

In the traveling apparatus 30 according to the third embodiment, the other components are substantially the same as those of the traveling apparatus 10 according to the first embodiment described above. Accordingly, identical parts are denoted by the same reference numerals, and the detailed description thereof is omitted.

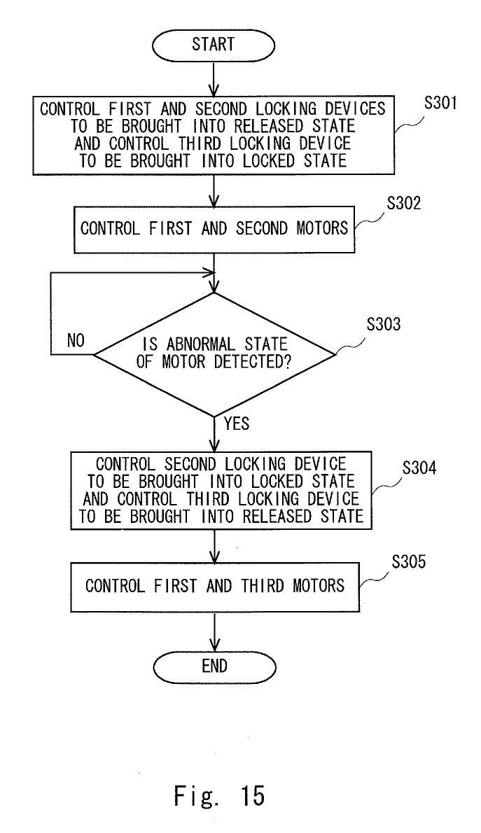

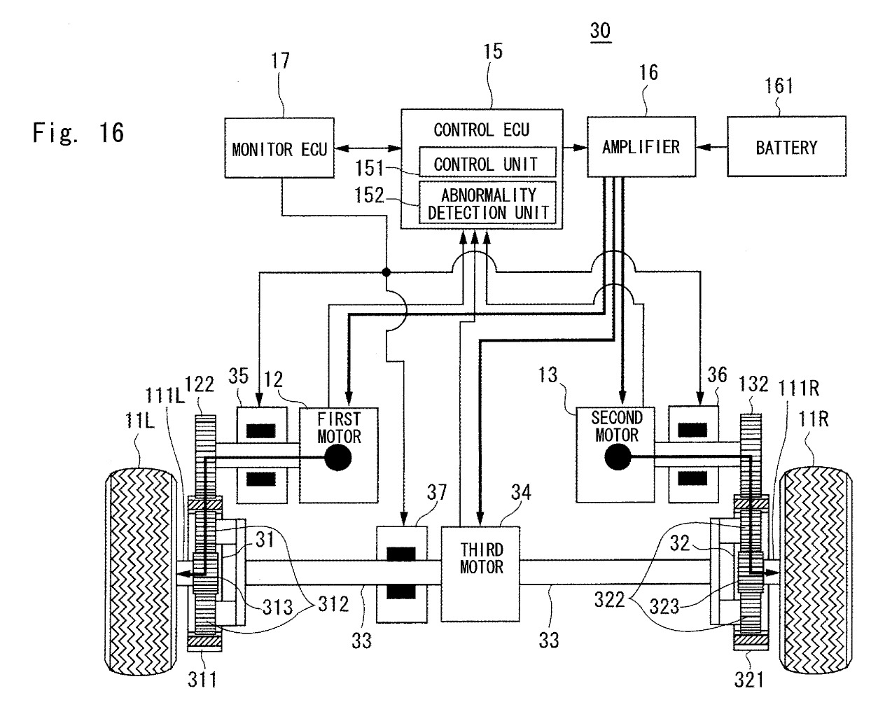

FIG. 15 is a flowchart showing an example of a control processing flow of the traveling apparatus according to the third embodiment. When the first and second motors 12 and 13 are in the normal state, for example, as shown in FIG. 16, the monitor ECU 17 receives no detection signal from the abnormality detection unit 152, and thus controls the first and second locking devices 35 and 36 to be brought into the released state and controls the third locking device 37 to be brought into the locked state (step S301). In this state, the control ECU 15 controls the rotational driving of each of the first and second motors 12 and 13 through the amplifier 16 (step S302). The first motor 12 controls the rotational driving of the first drive wheel 11L through the first locking device 35, the gear 122, the first planetary gear 31, and the axle 111L. The second motor 13 controls the rotational driving of the second drive wheel 11R through the second locking device 36, the gear 132, the second planetary gear 32, and the axle 111R.

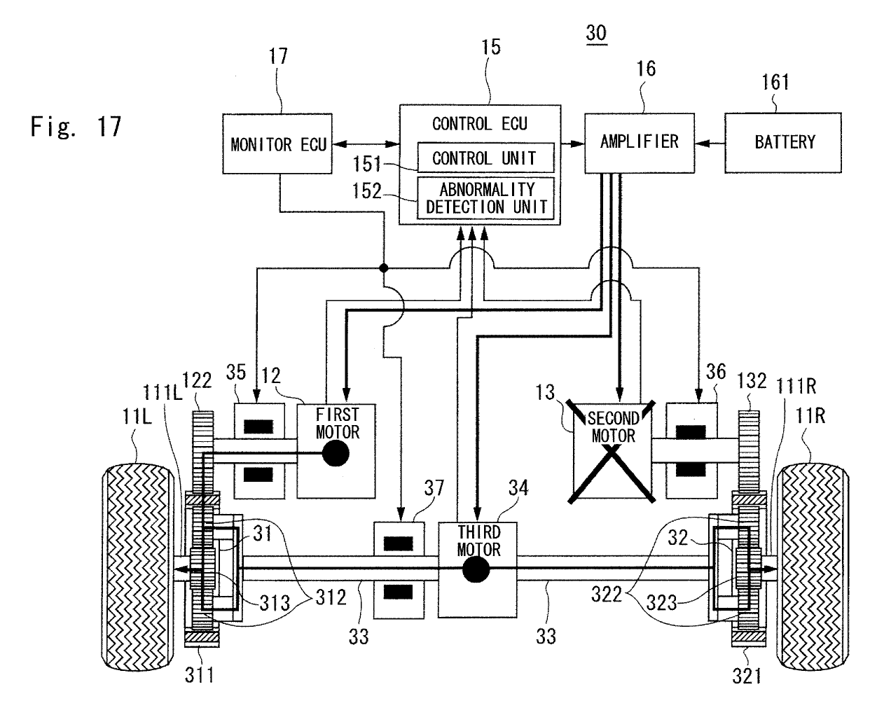

After that, as shown in FIG. 17, for example, if the second motor 13 breaks down, the abnormality detection unit 152 of the control ECU 15 detects the abnormal state of the second motor 13 based on the current value output from the current sensor of the second motor 13 (YES in step S303), and outputs the detection signal to the monitor ECU 17.

The monitor ECU 17 controls the second locking device 36, which is located on the side where the abnormal state is detected, to be brought into the locked state from the released state, and controls the third locking device 37 to be brought into the released state from the locked state, based on the detection signal from the abnormality detection unit 152 (step S304). In this state, the control ECU 15 controls the rotational driving of the first motor 12 through the amplifier 16, thereby enabling control of the rotational driving of the first drive wheel 11L through the first locking device 35, the gear 122, the first planetary gear 31, and the axle 111L, and controls the rotational driving of the third motor 34 through the amplifier 16, thereby enabling control of the rotational driving of the first and second drive wheels 11L and 11R through the intermediate shaft 33, the first and second planetary gears 31 and 32, and the axles 111L and 111R (step S305).

Note that in the above description, the case where the abnormal state of the second motor 13 is detected has been described. Also in the case where the abnormal state of the first motor 12 is detected, control processing similar to that for the first motor 12 is carried out. Accordingly, the detailed description thereof is omitted.

As described above, in the traveling apparatus 30 according to the third embodiment, even if an abnormality occurs in one of the first and second motors 12 and 13, the inversion control of the traveling apparatus 30 can be maintained only by providing one backup motor, and traveling such as forward movements, backward movements, right turn, and left turn can be controlled. That is, it is possible to maintain the travel performance, while achieving low cost.

Next, a modified example of the traveling apparatus 30 according to the third embodiment will be described.

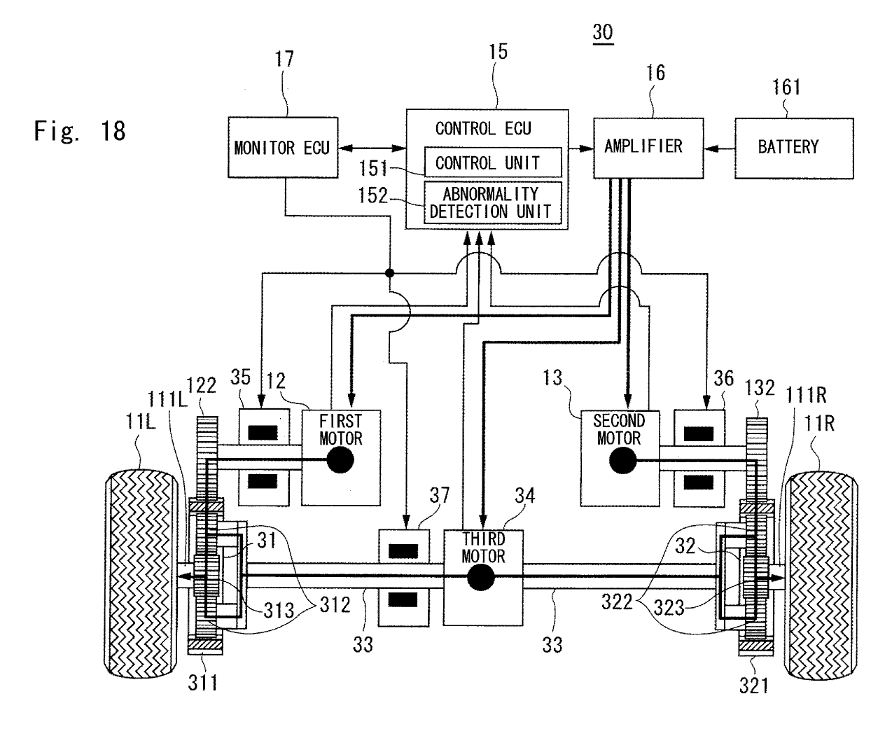

In the third embodiment described above, when the first and second motors 12 and 13 are in the normal state, the control ECU 15 controls the rotational driving of each of the first and second motors 12 and 13 through the amplifier 16, but the configuration of the control ECU 15 is not limited thereto. For example, the control ECU 15 may control the rotational driving of each of the first, second, and third motors 12, 13, and 34 to thereby control the traveling of the traveling apparatus 30 (FIG. 18).

In this case, the monitor ECU 17 controls each of the first, second, and third locking device 35, 36, 37 to be brought into the released state. The third motor 34 mainly drives the first and second drive wheels 11L and 11R. Further, one of the first and second motors 12 and 13 is driven to thereby generate a difference between the rotation of the first drive wheel 11L and the rotation of the second drive wheel 11R.

### Fourth Embodiment

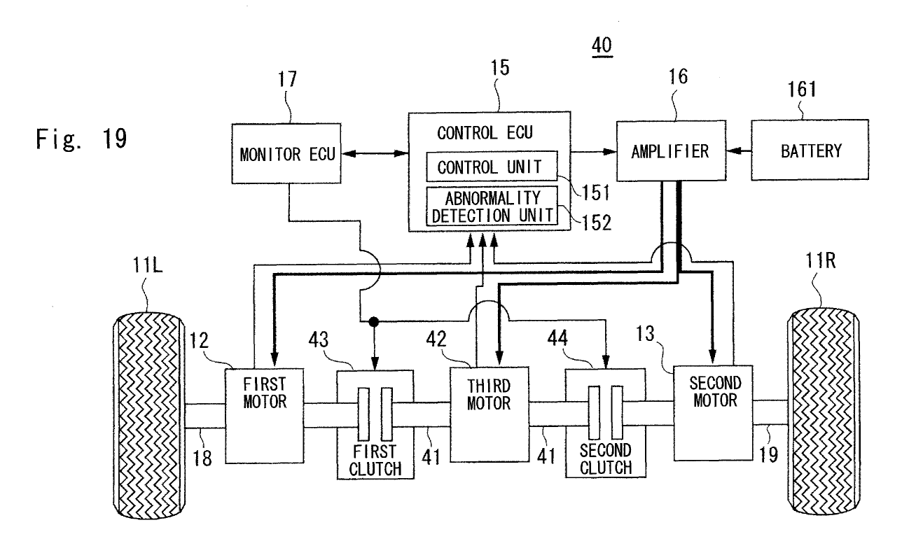

FIG. 19 is a block diagram showing a schematic system configuration of a traveling apparatus according to a fourth embodiment of the present invention. A traveling apparatus 40 according to the third embodiment includes an intermediate shaft 41 that connects the drive shaft 18 of the first drive wheel 11L and the drive shaft 19 of the second drive wheel 11R; a third motor 42 that drives the intermediate shaft 41; a first clutch 43 that switches the drive shaft 18 of the first drive wheel 11L and the intermediate shaft 41 between the connected state and the non-connected state; a second clutch 44 that switches the drive shaft 19 of the second drive wheel 11R and the intermediate shaft 41 between the connected state and the non-connected state; and the monitor ECU 17 that controls the first and second clutches 43 and 44 to be brought into the connected state and the non-connected state.

The intermediate shaft 41 is provided between the drive shaft 18 of the first drive wheel 11L and the drive shaft 19 of the second drive wheel 11R, and is connected to the drive shafts 18 and 19 via the first and second clutches 43 and 44, respectively. The third motor 42 is provided to the intermediate shaft 41, and is connected to the control ECU 15 via the amplifier 16. The control ECU 15 transmits the control signal to the amplifier 16 to thereby control the rotational driving of the third motor 42 through the amplifier 16.

The first and second clutches 43 and 44 are specific examples of first and second switching means, and switch the drive shaft 18 of the first drive wheel 11L and the intermediate shaft 41 between the connected state and the non-connected state and switch the drive shaft 19 of the second drive wheel 11R and the intermediate shaft 41 between the connected state and the non-connected state, according to the control signal from the monitor ECU 17.

In the traveling apparatus 40 according to the fourth embodiment, the other components are substantially the same as those of the traveling apparatus 10 according to the first embodiment described above. Accordingly, identical parts are denoted by the same reference numerals, and the detailed description thereof is omitted.

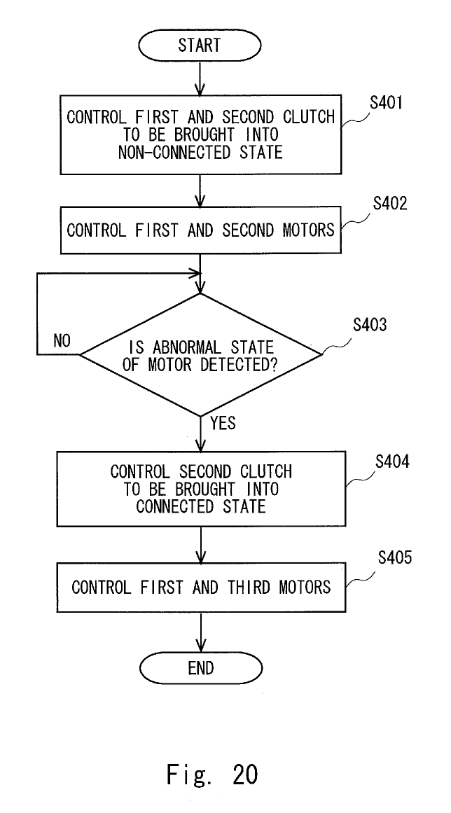

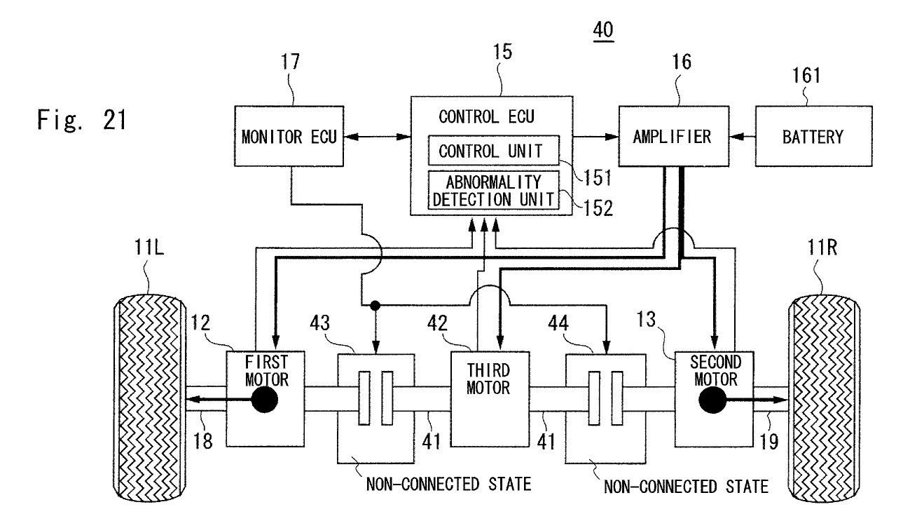

FIG. 20 is a flowchart showing an example of a control processing flow of the traveling apparatus according to the fourth embodiment. When the first and second motors 12 and 13 are in the normal state, for example, as shown in FIG. 21, the monitor ECU 17 receives no detection signal from the abnormality detection unit 152 of the control ECU 15, and thus controls the first and second clutches 43 and 44 to be brought into the non-connected state (step S401). In this state, the control ECU 15 controls the rotation driving of each of the first and second motors 12 and 13 through the amplifier 16 (step S402), thereby controlling the rotational driving of each of the first and second drive wheels 11L and 11R.

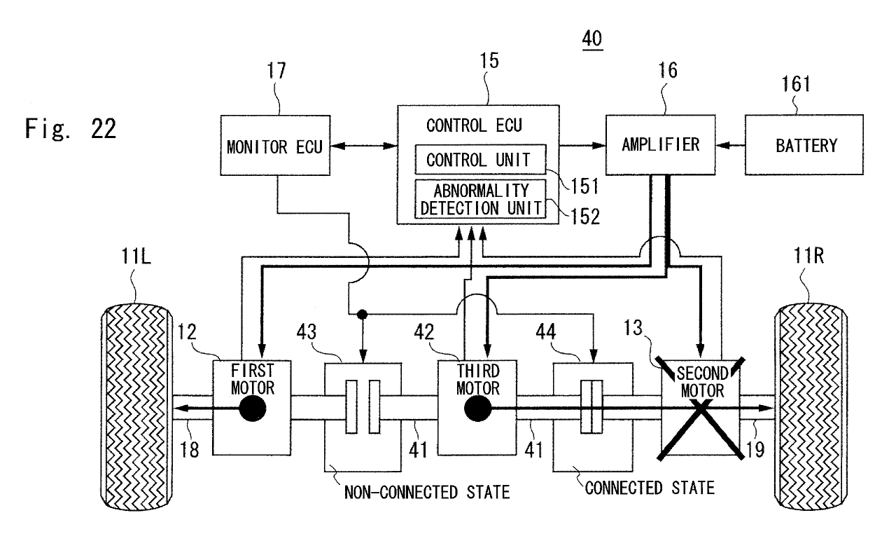

After that, as shown in FIG. 22, for example, if the second motor 13 breaks down, the abnormality detection unit 152 of the control ECU 15 detects the abnormal state of the second motor 13 based on the current value output from the current sensor of the second motor 13 (YES in step S403), and outputs the detection signal to the monitor ECU 17.

The monitor ECU 17 controls the second clutch 44, which is located on the side where the abnormal state is detected, to be brought into the connected state from the non-connected state, based on the detection signal from the abnormality detection unit 152 (step S404). In this state, the control ECU 15 controls the rotational driving of the first motor 12 through the amplifier 16, thereby enabling control of the rotational driving of the first drive wheel 11L, and controls the rotational driving of the third motor 42 through the amplifier 16, thereby enabling control of the rotational driving of the second drive wheel 11R through the intermediate shaft 41, the second clutch 44, and the drive shaft 19 (step S405).

Note that in the above description, the case where the abnormal state of the second motor 13 is detected has been described. Also in the case where the abnormal state of the first motor 12 is detected, control processing similar to that for the first motor 12 described above is carried out. Accordingly, the detailed description thereof is omitted.

As described above, in the traveling apparatus 40 according to the fourth embodiment, even if an abnormality occurs in one of the first and second motors 12 and 13, the inversion control of the traveling apparatus 40 can be maintained only by providing one backup motor, and traveling such as forward movements, backward movements, right turn, and left turn can be controlled. That is, it is possible to maintain the travel performance, while achieving low cost.

Note that the present invention is not limited to the embodiments described above, but can be modified as needed without departing from the scope of the present invention. For example, in the embodiments described above, the traveling apparatuses 10, 20, 30, and 40 are each configured as an inverted two-wheel vehicle, but the present invention is not limited thereto. Each of the traveling apparatuses may be configured as an inverted or non-inverted mono-cycle, tricycle, or four-wheel vehicle, for example. Furthermore, the first to fourth embodiments described above may be combined as desirable.

While in the above embodiments, the description has been made of an example where the present invention is implemented by hardware, the present invention is not limited thereto. The present invention can also be implemented by causing a CPU to execute the processings shown in FIGS. 2, 8, 15, and 20 as a computer program.

In this case, the computer program can be provided by recording the program in a recording medium. The computer program can also be transmitted through the Internet and other communication media.

Examples of the storage media include a flexible disk, a hard disk, a magnetic disk, a magneto-optical disk, a CD-ROM, a DVD, a ROM cartridge, a battery backup RAM memory cartridge, a flash memory cartridge, and a non-volatile RAM cartridge. Examples of the communication media include wired communication media such as a telephone line and wireless communication media such as a microwave line.

### INDUSTRIAL APPLICABILITY

The present invention is applicable to a traveling apparatus, such as an inverted two-wheel vehicle, which travels by driving drive wheels using motors, for example.

REFERENCE SIGNS LIST
10, 20, 30, 40 TRAVELING APPARATUS
11L FIRST DRIVE WHEEL
11R SECOND DRIVE WHEEL
12 FIRST MOTOR
13 SECOND MOTOR
14 CLUTCH
15 CONTROL ECU
16 AMPLIFIER
17 MONITOR ECU
22 FIRST CLUTCH
24 SECOND CLUTCH
25 THIRD CLUTCH
34 THIRD MOTOR
35 FIRST LOCKING DEVICE
36 SECOND LOCKING DEVICE
37 THIRD LOCKING DEVICE
43 FIRST CLUTCH
44 SECOND CLUTCH
151 CONTROL UNIT
152 ABNORMALITY DETECTION UNIT
311 FIRST PLANETARY GEAR
321 SECOND PLANETARY GEAR

1. A traveling apparatus comprising:
a first drive wheel and a second drive wheel, the first drive wheel and the second drive wheel being coaxially disposed;
a first motor that drives the first drive wheel;
a second motor that drives the second drive wheel;
a switch that switches a drive shaft of the first drive wheel and a drive shaft of the second drive wheel between a coupled state and a non-coupled state;
an abnormality detector that detects an abnormal state in the first and second motors; and
a controller that controls switching of the switch in accordance with the abnormal state detected by the abnormality detector.

2. The traveling apparatus according to claim 1, wherein when the abnormality detector detects the abnormal state, the controller controls the switch to switch the drive shaft of the first drive wheel and the drive shaft of the second drive wheel from the non-coupled state to the coupled state.

3. A traveling apparatus comprising:
a first drive wheel and a second drive wheel, the first drive wheel and the second drive wheel being coaxially disposed;
a first motor that drives the first drive wheel;
a second motor that drives the second drive wheel;
a first switch that switches a drive shaft of the first drive wheel and the first motor between a coupled state and a non-coupled state;
a second switch that switches a drive shaft of the second drive wheel and the second motor between the coupled state and the non-coupled state;
a third switch that switches the drive shaft of the first drive wheel and the drive shaft of the second drive wheel between the coupled state and the non-coupled state;
an abnormality detector that detects an abnormal state in the first and second motors; and
a controller that is programmed to controls the switching of the first, second, and third switch in accordance with the abnormal state detected by the abnormality detector.

4. The traveling apparatus according to claim 3, wherein when the abnormality detector detects the abnormal state, the controller controls the first and second switch located on a side where the abnormal state is detected, to be brought into the non-coupled state from the coupled state, and controls the third switch to be brought into the coupled state from the non-coupled state.

5. A traveling apparatus comprising:
a first drive wheel and a second drive wheel, the first drive wheel and the second drive wheel being coaxially disposed;
a first motor that drives the first drive wheel;
a second motor that drives the second drive wheel;
a first planetary gear engaging with each of the first drive wheel and the first motor;
a second planetary gear engaging with each of the second drive wheel and the second motor;
an intermediate shaft engaging with each of the first and second planetary gears;
a third motor that drives the intermediate shaft;
a first locking portion that brings a rotation of the first motor into a locked state and a released state;
a second locking portion that brings a rotation of the second motor into the locked state and the released state;
a third locking portion that brings a rotation of the intermediate shaft into the locked state and the released state;
an abnormality detector that detects an abnormal state in the first and second motors; and
a controller that is programmed to controls the first, second, and third locking portion to be brought into the locked state and the released state in accordance with the abnormal state detected by the abnormality detector.

6. The traveling apparatus according to claim 5, wherein when the abnormality detector detects the abnormal state, the controller controls the first and second locking portion located on a side where the abnormal state is detected, to be brought into the locked state from the released state, and controls the third locking portion to be brought into the released state from the locked state.

7. The traveling apparatus according to claim 5, wherein the first and second planetary gears respectively include:
ring gears respectively engaging with gears coupled to the drive shafts of the first and second motors;
a plurality of planetary gears respectively engaging with the ring gears and coupled to the intermediate shaft; and
sun gears respectively engaging with the planetary gears and coupled to axles of the first and second drive wheels.

8. A traveling apparatus comprising:
a first drive wheel and a second drive wheel, the first drive wheel and the second drive wheel being coaxially disposed;
a first motor that drives the first drive wheel;
a second motor that drives the second drive wheel;
an intermediate shaft that couples a drive shaft of the first drive wheel and a drive shaft of the second drive wheel;
a third motor that drives the intermediate shaft;
a first switch that switches the drive shaft of the first drive wheel and the intermediate shaft between a coupled state and a non-coupled state;
a second switch that switches the drive shaft of the second drive wheel and the intermediate shaft between the coupled state and the non-coupled state;
an abnormality detector that detects an abnormal state in the first and second motors; and
a controller that is programmed to controls the first and second switch to be brought into the coupled state and the non-coupled state in accordance with the abnormal state detected by the abnormality detector.

9. The traveling apparatus according to claim 8, wherein when the abnormality detector detects the abnormal state, the controller controls the first and second switch located on a side where the abnormal state is detected, to be brought into the coupled state from the non-coupled state.

10. A control method of a traveling apparatus, the traveling apparatus comprising:
a first drive wheel and a second drive wheel, the first drive wheel and the second drive wheel being coaxially disposed;
a first motor that drives the first drive wheel; and
a second motor that drives the second drive wheel, the control method comprising:
switching a drive shaft of the first drive wheel and a drive shaft of the second drive wheel between a coupled state and a non-coupled state;
detecting an abnormal state in the first and second motors; and
controlling the switching in accordance with the abnormal state detected.

11. A control method of a traveling apparatus,
the traveling apparatus comprising:
a first drive wheel and a second drive wheel, the first drive wheel and the second drive wheel being coaxially disposed;
a first motor that drives the first drive wheel; and
a second motor that drives the second drive wheel,
the control method comprising:
switching a drive shaft of the first drive wheel and the first motor between a coupled state and a non-coupled state;
switching a drive shaft of the second drive wheel and the second motor between the coupled state and the non-coupled state;
switching the drive shaft of the first drive wheel and the drive shaft of the second drive wheel between the coupled state and the non-coupled state;
detecting an abnormal state in the first and second motors; and
controlling the switching in accordance with the abnormal state detected.

12. A control method of a traveling apparatus, the traveling apparatus comprising:
a first drive wheel and a second drive wheel, the first drive wheel and the second drive wheel being coaxially disposed;
a first motor that drives the first drive wheel;
a second motor that drives the second drive wheel;
a first planetary gear engaging with each of the first drive wheel and the first motor;
a second planetary gear engaging with each of the second drive wheel and the second motor;
an intermediate shaft engaging with each of the first and second planetary gears; and
a third motor that drives the intermediate shaft,
the control method comprising:
bringing a rotation of the first motor into a locked state and a released state;
bringing a rotation of the second motor into the locked state and the released state;
bringing a rotation of the intermediate shaft into the locked state and the released state;
detecting an abnormal state in the first and second motors; and
controlling the locked state and the released state in accordance with the abnormal state detected.

13. A control method of a traveling apparatus, the traveling apparatus comprising:
a first drive wheel and a second drive wheel, the first drive wheel and the second drive wheel being coaxially disposed;
a first motor that drives the first drive wheel;
a second motor that drives the second drive wheel;
an intermediate shaft that couples a drive shaft of the first drive wheel and a drive shaft of the second drive wheel; and
a third motor that drives the intermediate shaft,
the control method comprising:
switching the drive shaft of the first drive wheel and the intermediate shaft between a coupled state and a non-coupled state;
switching the drive shaft of the second drive wheel and the intermediate shaft between the coupled state and the non-coupled state;
detecting an abnormal state in the first and second motors; and
controlling the coupled state and the non-coupled state in accordance with the abnormal state detected.

14. A control program of a traveling apparatus, the traveling apparatus comprising:
a first drive wheel and a second drive wheel, the first drive wheel and the second drive wheel being coaxially disposed;
a first motor that drives the first drive wheel; and
a second motor that drives the second drive wheel,
the control program causing a computer to execute processing including:
switching a drive shaft of the first drive wheel and a drive shaft of the second drive wheel between a coupled state and a non-coupled state;
detecting an abnormal state in the first and second motors; and
controlling the switching based the abnormal state detected.

15. A traveling apparatus comprising:
a first drive wheel and a second drive wheel, the first drive wheel and the second drive wheel being coaxially disposed;
a first motor that drives the first drive wheel;
a second motor that drives the second drive wheel;
switching means that switches a drive shaft of the first drive wheel and a drive shaft of the second drive wheel between a coupled state and a non-coupled state;
abnormality detection means that detects an abnormal state in the first and second motors; and
control means that is programmed to controls switching of the switching means in accordance with the abnormal state detected by the abnormality detection means.
